(19) United States
(12) Patent Application Publication
(10) Pub. No.: US 2024/0184297 A1
(43) Pub. Date: Jun. 6, 2024

(54) METHOD FOR POSITIONING AN UNMANNED VEHICLE

(71) Applicant: CHINA MOTOR CORPORATION, Taipei (TW)

(72) Inventors: Yu-Sung CHEN, Taipei (TW); Jing-Xiang ZHANG, Taipei (TW)

(73) Assignee: CHINA MOTOR CORPORATION, Taipei (TW)

(21) Appl. No.: 18/089,860

(22) Filed: Dec. 28, 2022

(30) Foreign Application Priority Data
Dec. 6, 2022 (TW) 111146717

(51) Int. Cl. G05D 1/02; G01S 7/48; G01S 17/931

(52) U.S. Cl. CPC G05D 1/024; G01S 7/4808; G01S 17/931; G05D 1/0274

(57) ABSTRACT

An unmanned vehicle is disposed in a predetermined area, and is provided with a lidar unit that emits light beams to acquire light sensing data pieces, each containing distance information and a light intensity value. The unmanned vehicle acquires a detection value representing a number of those of the light sensing data pieces whose light intensity values are greater than a light intensity threshold. When the detection value is zero, a first pose of the unmanned vehicle is calculated based on a moving speed and a moving direction of the unmanned vehicle. When the detection value is not zero, a second pose of the unmanned vehicle is calculated based on the moving speed, the moving direction and positions of multiple reflective marks disposed in the predetermined area, as recorded in an area map of the predetermined area.

### CROSS-REFERENCE TO RELATED APPLICATION

This application claims priority to Taiwanese Invention Patent Application No. 111146717, filed on Dec. 6, 2022.

### FIELD

The disclosure relates to an unmanned vehicle, and more particularly to a method for positioning an unmanned vehicle.

### BACKGROUND

A conventional unmanned vehicle is positioned using adaptive Monte Carlo localization (AMCL), which uses a set of initial coordinates to predict several sets of estimated coordinates and generate possible weights for the sets of estimated coordinates, and then uses the sets of estimated coordinates with higher weights to obtain a new positioning point. Although this method can achieve a certain degree of accuracy, with repeated iterations over time, the calculated positioning points will gradually become inaccurate.

### SUMMARY

Therefore, an object of the disclosure is to provide a localization method that can alleviate at least one of the drawbacks of the prior art.

According to the disclosure, the localization method is provided for positioning an unmanned vehicle, and includes steps of: by a computing unit of the unmanned vehicle, receiving an initial coordinate set, wherein the unmanned vehicle is disposed in a predetermined area provided with multiple reflective marks, and an amount of the reflective marks is not less than three, and wherein the unmanned vehicle has an area map of the predetermined area built therein, and the area map records positions of the reflective marks; by a lidar unit that is disposed on the unmanned vehicle, emitting a plurality of light beams, and acquiring a plurality of light sensing data pieces relating to an obstacle within a range defined by a predetermined distance from the lidar unit, wherein the light sensing data pieces respectively correspond to the light beams, and each of the light sensing data pieces contains distance information that corresponds to a distance between the lidar unit and an obstacle measured by the time of flight of the corresponding one of the light beams, and a light intensity value that is related to reflection of the corresponding one of the light beams; by the computing unit, obtaining a detection value that is a number of those of the light sensing data pieces whose light intensity values are greater than a light intensity threshold; by the computing unit, when the detection value is zero, executing a first localization procedure based on a moving speed and a moving direction of the unmanned vehicle to calculate a first pose of the unmanned vehicle with respect to the area map, and calculating a first comparison value that is related to a comparison between the area map and first area information calculated based on the first pose and the light sensing data pieces; by the computing unit, upon determining that the first comparison value is greater than a first comparison threshold, making the first pose serve as a current pose of the unmanned vehicle; by the computing unit, when the detection value is not zero, executing a second localization procedure based on the moving speed, the moving direction, and the positions of the reflective marks as recorded in the area map to calculate a second pose of the unmanned vehicle with respect to the area map, and calculating a second comparison value that is related to a comparison between the area map and second area information calculated based on the second pose and the light sensing data pieces; and by the computing unit, upon determining that the second comparison value is greater than a second comparison threshold, making the second pose serve as the current pose of the unmanned vehicle.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating an unmanned vehicle that implements an embodiment of the localization method according to the disclosure is disposed in a predetermined area.

FIG. 2 is a block diagram illustrating the unmanned vehicle.

FIG. 3 is a flow chart illustrating steps of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

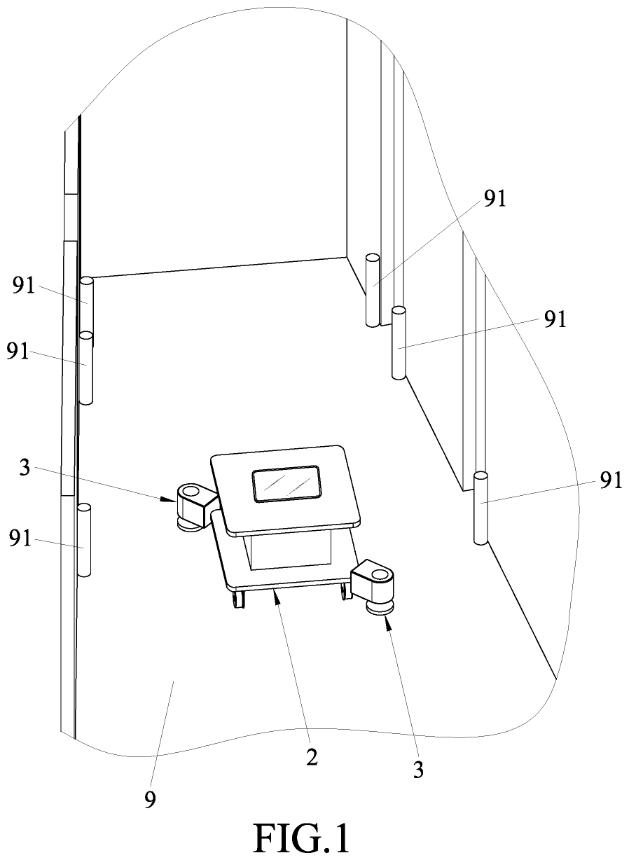

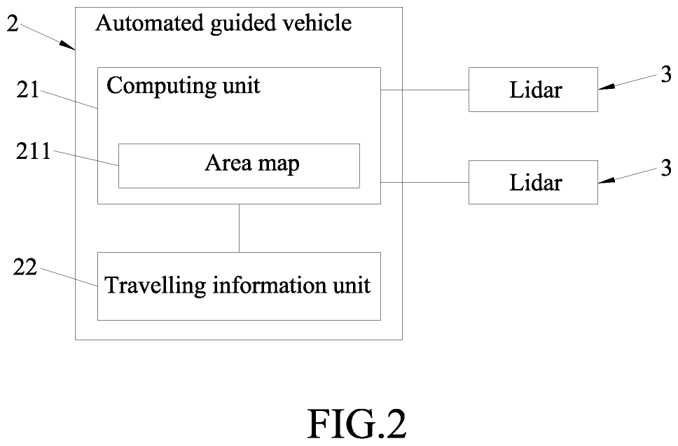

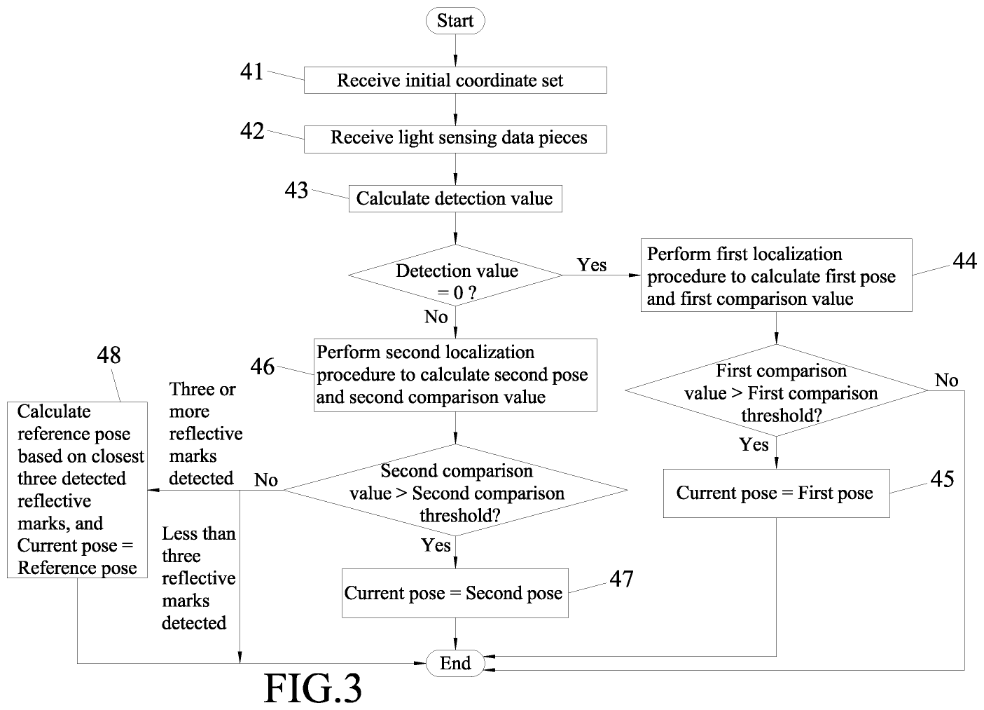

Referring to FIGS. 1 to 3, an embodiment of a localization method according to this disclosure is adapted for positioning an unmanned vehicle 2 that is disposed and movable in a predetermined area (region) 9, where the predetermined area 9 is provided with at least three reflective marks 91. In this embodiment, the reflective marks 91 are realized using reflective strips. The unmanned vehicle 2 includes a computing unit 21 and a travelling information unit 22. The computing unit 21 has an area map 211 of the predetermined area 9 built therein, and the area map 211 records positions of the reflective marks 91 in the predetermined area 9. The travelling information unit 22 is configured to generate information of a moving speed and a moving direction of the unmanned vehicle 2, which can be calculated based on rotational speeds of wheels of the unmanned vehicle 2 and distances among the wheels of the unmanned vehicle 2. In this embodiment, the computing unit 21 may be realized as a microcontroller, and the travelling information unit 22 may be realized as a controller area network (CAN).

The unmanned vehicle 2 is provided with a lidar unit mounted thereon. In this embodiment, the lidar unit includes two lidars 3 that are electrically connected to the computing unit 21. Each of the lidars 3 is configured to emit multiple light beams to acquire a plurality of light sensing data pieces relating to an obstacle within an effective range of the lidar 3, which is defined by a predetermined distance from the lidar 3, where the light sensing data pieces respectively correspond to the light beams. Each of the light sensing data pieces contains distance information that corresponds to a distance between the lidar 3 that emitted the corresponding light beam and an obstacle that was struck by the corresponding light beam, and a light intensity value that is related to reflection of the corresponding light beam (hereinafter referred to as “reflected beam”). In this embodiment, the lidars 3 are located at two opposite corners (e.g., a front-left corner and a rear-right corner in FIG. 1) of the unmanned vehicle 2, respectively. Each lidar 3 is configured to emit 540 light beams horizontally within an angular range of 270 degrees, and the predetermined distance is thirty meters. In other embodiments, the lidars 3 with different light emission specifications (e.g., emitting different numbers of the light beams within a different angular range, and having a different effective distance that serves as the predetermined distance) may be used based on actual needs. When a light beam strikes and is reflected by an obstacle within the effective range and the lidar 3 receives the reflected beam, the lidar 3 measures light intensity of the reflected beam to generate the light intensity value of the light sensing data piece that corresponds to the light beam, and the distance between the lidar 3 and the obstacle in a specific direction is calculated based on a time of flight (ToF) of the light beam. When an obstacle is outside of the effective range (i.e., a distance between the obstacle and the lidar 3 is greater than the predetermined distance), the lidar 3 may be unable to calculate the distance between the lidar 3 and the obstacle correctly. When the light beams hit one of the reflective marks 91 and a wall that are disposed at the same distance from the lidar 3, light beams reflected by the reflective mark 91 would have higher light intensities than light beams reflected by the wall because the reflective marks 91 are made of a material with a high reflection coefficient (e.g., greater than 66%), which is higher than that of the wall.

The embodiment of the method includes steps 41 to 48. In step 41, the computing unit 21 receives an initial coordinate set. In this embodiment, the initial coordinate set is provided through an external input, and is used for the unmanned vehicle 2 to perform initial localization with respect to the area map 211.

In step 42, the lidars 3 acquire a plurality of light sensing data pieces. The computing unit 21 receives the light sensing data pieces from the lidars 3.

In step 43, the computing unit 21 obtains a detection value that is a number of those of the light sensing data pieces whose light intensity values are greater than a light intensity threshold. In this embodiment, the light intensity threshold is used to determine, for each of the light sensing data pieces, whether the corresponding light beam is reflected by a reflective mark 91. Therefore, the detection value represents a total number of those of the light beams that are reflected by the reflective mark(s) 91 and detected by the lidars 3. When a light sensing data piece has a light intensity value greater than the light intensity threshold, the computing unit 21 determines that the corresponding light beam is reflected by a reflective mark 91, and can estimate a relative position of the reflective mark 91 thus detected based on the distance information of the light sensing data piece, and also estimate a direction of emission of the corresponding light beam and/or a direction of reflection of the corresponding light beam.

When the detection value is zero, which means that none of the reflective marks 91 is detected, in step 44, the computing unit 21 executes a first localization procedure based on the initial coordinate set and the moving speed and the moving direction of the unmanned vehicle 2, so as to calculate a first pose (i.e., a position and an orientation) of the unmanned vehicle 2 with respect to the area map 211. Then, the computing unit 21 calculates a piece of first area information relating to surroundings of the unmanned vehicle 2 based on the first pose and the light sensing data pieces, and then calculates a first comparison value that is related to a comparison between the area map 211 and the first area information.

In this embodiment, the first localization procedure is a computing procedure that utilizes adaptive Monte Carlo localization (AMCL). In the first localization procedure, the computing unit 21 makes a prediction for a new pose (namely, current pose) of the unmanned vehicle 2 based on the initial coordinate set and the moving speed and the moving direction of the unmanned vehicle 2, and uses the prediction for the new pose to generate multiple guesses for the new pose and multiple weights respectively corresponding to the guesses, where the weights may be generated using a likelihood field measurement model that calculates a degree of matching between the area map 211 and the distances from the obstacles detected by the light beams. The computing unit 21 then classifies the guesses into multiple groups based on, for example but not limited to, Kullback-Leibler divergence (KLD). Each of the groups thus classified has a weight average, which is an average of those of the weights that correspond to the guesses in the group, and the computing unit 21 calculates the first pose based on one of the groups of which the weight average is the greatest among the weight averages of all the groups. In this embodiment, the first pose includes an X-axis coordinate and a Y-axis coordinate that cooperate to define a planar location of the unmanned vehicle 2, and a θ-axis coordinate that is an angular coordinate representing a direction the unmanned vehicle 2 faces. Since the generation of the multiple guesses and the multiple weights of the adaptive Monte Carlo localization should be known to one skilled in the art, details thereof are omitted herein for the sake of brevity.

In this embodiment, the area map 211 has a plurality of predetermined obstacle coordinate sets that respectively represent a plurality of predetermined obstacle data points on the area map 211. In order to calculate the first comparison value, the computing unit 21 transforms, based on the first pose and the distance information of the light sensing data pieces, the light sensing data pieces into a plurality of first detection-based obstacle coordinate sets that respectively represent a plurality of first detection-based obstacle data points on the area map 211 (e.g., obtained by mapping the first detection-based obstacle coordinate sets onto the area map 211), where a number (quantity) of the first detection-based obstacle data points is a positive integer denoted by m. Then, the computing unit 21 calculates a number (quantity) of those of the first detection-based obstacle data points that overlap the predetermined obstacle data points, which is a positive integer denoted by n, and makes the first comparison value equal to n/m.

Upon determining that the first comparison value is greater than a first comparison threshold, in step 45, the computing unit 21 makes the first pose serve as the current pose of the unmanned vehicle 2. In this embodiment, the first comparison threshold is set to 0.5, but this disclosure is not limited in this respect. The value of the first comparison threshold may be adjusted based on the area (region) where the unmanned vehicle 2 is disposed.

When the computing unit 21 determines that the first comparison value is not greater than the first comparison threshold, which means that positioning of the unmanned vehicle 2 no longer accurate and the unmanned vehicle 2 is getting lost, the computing unit 21 may stop the unmanned vehicle 2 from moving to prevent accidents.

When the detection value is not zero, which means that one or more reflective marks 91 have been detected, in step 46, the computing unit 21 determines one or more detected reflective marks 91 and obtains a detected location of each detected reflective mark 91 relative to the unmanned vehicle 2 based on those of the light sensing data pieces whose light intensity values are greater than the light intensity threshold. Then, the computing unit 21 executes a second localization procedure based on the initial coordinate set, the moving speed and the moving direction of the unmanned vehicle 2, and the positions of the reflective marks 91 (particularly, the position(s) of the detected reflective mark(s) 91) as recorded in the area map 211, so as to calculate a second pose of the unmanned vehicle 2 with respect to the area map 211. Then, the computing unit 21 calculates a piece of second area information with respect to surroundings of the unmanned vehicle 2 based on the second pose and the light sensing data pieces, and then calculates a second comparison value that is related to a comparison between the area map 211 and the second area information. When the detection value is not zero, the computing unit 21, based on those of the light sensing data pieces whose light intensity values are greater than the light intensity threshold, makes at least one of the reflective marks 91 serve as at least one detected reflective mark and obtains a location of the at least one detected reflective mark relative to the unmanned vehicle 2.

In the second localization procedure, the computing unit 21 makes a prediction for a new pose of the unmanned vehicle 2 based on the initial coordinate set and the moving speed and the moving direction of the unmanned vehicle 2, and uses the prediction for the new pose to generate multiple guesses for the new pose and multiple weights respectively corresponding to the guesses. The second localization procedure differs from the first localization procedure in that, in the second localization procedure, the computing unit 21 increases at least one of the weights by, for example, multiplying it by a predetermined ratio greater than one. In this embodiment, the predetermined ratio is set to 100, but this disclosure is not limited in this respect. In detail, the computing unit 21 determines, for each of the weights, whether a relative location of each detected reflective mark 91 with respect to the corresponding guess on the area map 211 matches the detected location of the detected reflective mark 91 as obtained based on the light sensing data pieces, and increases the weight when the determination is affirmative. Therefore, for each of the at least one of the weights that is increased by the computing unit 21, a relative location of one of the reflective marks 91 with respect to the corresponding guess on the area map 211 matches the detected location of one of the detected reflective mark(s) 91 as obtained based on the light sensing data pieces. The computing unit 21 then classifies the guesses into multiple groups. Each of the groups thus classified has a weight average, which is an average of those of the weights that correspond to the guesses in the group, and the computing unit 21 calculates the second pose based on one of the groups of which the weight average is the greatest among the weight averages of all the groups. In this embodiment, the second pose includes an X-axis coordinate and a Y-axis coordinate that cooperate to define a planar location of the unmanned vehicle 2, and a θ-axis coordinate that is an angular coordinate representing a direction the unmanned vehicle 2 faces.

In order to calculate the second comparison value, the computing unit 21 transforms, based on the second pose and the distance information of the light sensing data pieces, the light sensing data pieces into a plurality of second detection-based obstacle coordinate sets that respectively represent a plurality of second detection-based obstacle data points on the area map 211 (e.g., obtained by mapping the second detection-based obstacle coordinate sets onto the area map 211), where a number (quantity) of the second detection-based obstacle data points is a positive integer denoted by q. Then, the computing unit 21 calculates a number (quantity) of those of the second detection-based obstacle data points that overlap the predetermined obstacle data points, which is a positive integer denoted by r, and makes the second comparison value equal to r/q.

Upon determining that the second comparison value is greater than a second comparison threshold, in step 47, the computing unit 21 makes the second pose serve as the current pose of the unmanned vehicle 2. Since the reflective marks 91 enhance the feature of the scene in this case, the matching ratio of this case is not required to be as large as that for the conventional AMCL, and the second comparison threshold can be made smaller than the first comparison threshold. In this embodiment, the second comparison threshold is set to 0.2, but this disclosure is not limited to such. The value of the second comparison threshold may be adjusted based on the area where the unmanned vehicle 2 is disposed, and is not necessarily smaller than the first comparison threshold.

Upon determining that the second comparison value is not greater than the second comparison threshold and when the light sensing data pieces indicate that at least three of the reflective marks 91 have been detected (the reflective marks 91 can be identified by grouping those of the light sensing data pieces whose light intensity values are greater than the light intensity threshold), in step 48, the computing unit 21 calculates a reference pose based on, among the at least three detected reflective marks 91, the closest three of the reflective marks 91 and the positions of the closest three of reflective marks 91 as recorded in the area map 211, and makes the reference pose serve as the current pose of the unmanned vehicle 2.

In detail, when the computing unit 21 determines that the second comparison value is not greater than the second comparison threshold and that at least three of the reflective marks 91 have been detected, the computing unit 21 acquires, based on the light sensing data pieces, side lengths and angles of a detection-based triangle formed by the closest three of the detected reflective marks 91, and acquires, for any three of the positions of the reflective marks 91 recorded in the area map 211, side lengths and angles of a map-based triangle formed by the three of the positions of the reflective marks 91. Then, the computing unit 21 compares the side lengths and the angles of the detection-based triangle with the side lengths and the angles of each of the map-based triangle(s) (when more than three reflective marks 91 are disposed in the predetermined area 9, there would be multiple map-based triangles in the area map 211) so as to find a target map-based triangle that is one of the map-based triangle(s) and that corresponds to the detection-based triangle. Eventually, the computing unit 21 performs coordinate transformation based on three of the positions of the reflective marks 91 that form the target map-based triangle and positions of the closest three of the detected reflective marks 91 relative to the unmanned vehicle 2, so as to calculate the reference pose. The coordinate transformation may be accomplished by, for example, matrix or vector operations, which should be known to one skilled in the art, so details thereof are omitted herein for the sake of brevity.

When the computing unit 21 determines that the second comparison value is not greater than the second comparison threshold and that a number of the detected reflective marks 91 is smaller than three, which means that positioning of the unmanned vehicle 2 is no longer accurate and the unmanned vehicle 2 is getting lost, the computing unit 21 may stop the unmanned vehicle 2 from moving to prevent accidents.

The current pose acquired in step 45, step 47 or step 48 can be used as the initial coordinate set for the next localization of the unmanned vehicle 2, so the pose of the unmanned vehicle 2 can keep being updated as the unmanned vehicle 2 moves.

To sum up, in the second localization procedure, the location(s) of the detected reflective mark(s) are used to determine which weight(s) should be increased, so as to promote accuracy and precision of localization, and thus solve the problem the conventional adaptive Monte Carlo localization that would otherwise have been encountered, namely that positioning points may gradually become inaccurate. Further, the embodiment provides three different localization procedures to position the unmanned vehicle 2 in response to different detection results, thereby optimizing the accuracy and precision of localization under different situations.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for positioning an unmanned vehicle, comprising steps of:
by a computing unit of the unmanned vehicle, receiving an initial coordinate set, wherein the unmanned vehicle is disposed in a predetermined area provided with multiple reflective marks, and an amount of the reflective marks is not less than three, and wherein the unmanned vehicle has an area map of the predetermined area built therein, and the area map records positions of the reflective marks;
by a lidar unit that is disposed on the unmanned vehicle, emitting a plurality of light beams, and acquiring a plurality of light sensing data pieces relating to an obstacle within a range defined by a predetermined distance from the lidar unit, wherein the light sensing data pieces respectively correspond to the light beams, and each of the light sensing data pieces contains distance information that corresponds to a distance between the lidar unit and an obstacle struck by the corresponding one of the light beams, and a light intensity value that is related to reflection of the corresponding one of the light beams;
by the computing unit, obtaining a detection value that is a number of those of the light sensing data pieces whose light intensity values are greater than a light intensity threshold;
by the computing unit, when the detection value is zero, executing a first localization procedure based on a moving speed and a moving direction of the unmanned vehicle to calculate a first pose of the unmanned vehicle with respect to the area map, and calculating a first comparison value that is related to a comparison between the area map and first area information calculated based on the first pose and the light sensing data pieces;
by the computing unit, upon determining that the first comparison value is greater than a first comparison threshold, making the first pose serve as a current pose of the unmanned vehicle;
by the computing unit, when the detection value is not zero, executing a second localization procedure based on the moving speed, the moving direction, and the positions of the reflective marks as recorded in the area map to calculate a second pose of the unmanned vehicle with respect to the area map, and calculating a second comparison value that is related to a comparison between the area map and second area information calculated based on the second pose and the light sensing data pieces; and
by the computing unit, upon determining that the second comparison value is greater than a second comparison threshold, making the second pose serve as the current pose of the unmanned vehicle.

2. The method as claimed in claim 1, further comprising a step of:
by the computing unit, upon determining that the second comparison value is not greater than the second comparison threshold and when the light sensing data pieces indicate that at least three of the reflective marks have been detected, calculating a reference pose based on, among the at least three of the reflective marks that have been detected, closest three of the reflective marks and the positions of the closest three of reflective marks as recorded in the area map, and making the reference pose serve as the current pose of the unmanned vehicle.

3. The method as claimed in claim 2, wherein the step of calculating the reference pose includes:
acquiring side lengths and angles of a detection-based triangle formed by the closest three of the reflective marks that have been detected;
acquiring, for any three of the positions of the reflective marks recorded in the area map, side lengths and angles of a map-based triangle formed by the three of the positions of the reflective marks;
finding a target map-based triangle that is one of the map-based triangle(s) and that corresponds to the detection-based triangle by comparing the side lengths and the angles of the detection-based triangle with the side lengths and the angles of each of the map-based triangle(s); and
performing coordinate transformation based on three of the positions of the reflective marks that form the target map-based triangle and positions, relative to the unmanned vehicle, of the closest three of the reflective marks that have been detected, so as to calculate the reference pose.

4. The method as claimed in claim 1, wherein the first localization procedure is a computing procedure that utilizes adaptive Monte Carlo localization, and includes:
making a prediction for a new pose of the unmanned vehicle based on the moving speed and the moving direction;
using the prediction for the new pose to generate multiple guesses for the new pose and multiple weights respectively corresponding to the guesses;
classifying the guesses into multiple groups each having a weight average, which is an average of those of the weights that correspond to the guesses in the group; and
calculating the first pose based on one of the groups of which the weight average is the greatest among the weight averages of all the groups.

5. The method as claimed in claim 1, wherein, when the detection value is not zero, the computing unit determines at least one detected reflective mark and obtains a detected location of the at least one detected reflective mark relative to the unmanned vehicle based on those of the light sensing data pieces whose light intensity values are greater than the light intensity threshold;
wherein the second localization procedure includes:
making a prediction for a new pose of the unmanned vehicle based on the moving speed and the moving direction;
using the prediction for the new pose to generate multiple guesses for the new pose and multiple weights respectively corresponding to the guesses; and
increasing at least one of the weights by multiplying the at least one of the weights by a predetermined ratio;
wherein a location of at least one of the reflective marks relative to at least one of the guesses that corresponds to the at least one of the weights on the area map matches the detected location of the at least one detected reflective mark obtained based on the light sensing data pieces; and
wherein the second localization procedure further includes:
classifying the guesses into multiple groups each having a weight average, which is an average of those of the weights that correspond to the guesses in the group; and
calculating the second pose based on one of the groups of which the weight average is the greatest among the weight averages of all of the groups.

6. The method as claimed in claim 1, wherein the area map has a plurality of predetermined obstacle coordinate sets that respectively represent a plurality of predetermined obstacle data points on the area map;
wherein calculating the first comparison value includes:
transforming, based on the first pose, the light sensing data pieces into a plurality of detection-based obstacle coordinate sets that respectively represent a plurality of detection-based obstacle data points on the area map, where a number of the detection-based obstacle data points is a positive integer denoted by m;
calculating a number of those of the detection-based obstacle data points that overlap the predetermined obstacle data points, which is a positive integer denoted by n; and
making the first comparison value equal to n/m.

7. The method as claimed in claim 1, wherein the area map has a plurality of predetermined obstacle coordinate sets that respectively represent a plurality of predetermined obstacle data points on the area map;
wherein calculating the second comparison value includes:
transforming, based on the second map pose, the light sensing data pieces into a plurality of detection-based obstacle coordinate sets that respectively represent a plurality of detection-based obstacle data points on the area map, where a number of the detection-based obstacle data points is a positive integer denoted by q;
calculating a number of those of the detection-based obstacle data points that overlap the predetermined obstacle data points, which is a positive integer denoted by r; and
making the second comparison value equal to r/q.
